(19) United States
(12) Patent Application Publication
(10) Pub. No.: US 2007/0240921 A1
(43) Pub. Date: Oct. 18, 2007

(54) Method and Device for Operating a Hybrid Vehicle

(75) Inventors: Steffen Katzenberger, Bad Liebenzell (DE); Markus Widenmeyer, Schoenaich (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 11/587,465

(22) PCT Filed: Mar. 29, 2005
(86) PCT No.: PCT/EP05/51422

§ 371 Date: Oct. 25, 2006

(30) Foreign Application Priority Data
Apr. 30, 2004 (DE) 10 2004 021 370.4

(51) Int. Cl. B60K 6/04

(52) U.S. Cl. 180/65.2

(57) ABSTRACT

Disclosed are a method for operating a hybrid vehicle, in which a predefined setpoint torque is cumulatively generated by at least one internal combustion engine and at least one electric motor, and a device for carrying out said method. According to the invention, the torque contribution of the internal combustion engine is defined in accordance with at least one exhaust gas parameter in a first step while the torque contribution of the electric motor is defined in a second step based on the difference between the setpoint torque and the torque contribution of the internal combustion engine defined in the first step. The inventive method allows the internal combustion engine to be operated in an optimal fashion regarding emissions.

### FIELD OF THE INVENTION

The invention concerns a procedure for operation of a hybrid vehicle and a device to implement the procedure according to the invention according to the class of independent claims.

### BACKGROUND

In the German patent DE 101 28 758 A1 a procedure according to the class is described in which a specified torque target value is achieved by successively adding at least one internal combustion engine and at least one electromotor. The internal combustion engine and the electromotor work together by way of a transmission on the drive wheels of a hybrid vehicle. The control of the electromotor is dependent upon information on elevation that is provided by a navigation system. The control on the basis of the information on elevation has the advantage, that a lower minimum state of charge of the energy source provided for the electromotor can be provided because a calculable energy extraction occurring on the descent following an uphill climb can be planned into the charging of the energy source by means of the electromotor working as a generator. By way of the targeted application of the electromotor especially under the elevated torque demands of an ascent, the internal combustion engine can be operated in a state favorable to reduced fuel consumption. Altogether a reduced energy consumption of the hybrid vehicle is realized by planning in the estimated recoverable energy occurring during the descent.

In the German patent DE 199 23 299 A1 a procedure for the control of the internal combustion engine is described, in which a particle filter is placed in the exhaust area of the motor. The necessary temperature required to initiate a regeneration is implemented if need be by way of a required increase in exhaust temperature. The increase in the exhaust temperature results from an intervention into the fuel supply of the internal combustion engine, whereby the point of injection time is shifted in the retarded (late) direction, so that due to the reduction of the efficiency of the internal combustion engine, an increased exhaust temperature emerges.

In the German patent DE 100 43 366 A1 an internal combustion engine is described, in whose exhaust system a catalytic converter is placed which under certain operating conditions must be brought to an increased operating temperature. A possibility for increasing the operating temperature of the catalytic converter can be realized by way of increasing the exhaust temperature. The exhaust temperature of the externally ignited internal combustion engine, which forms the basis of the study, can be influenced by an adjustment of the ignition timing.

An externally ignited internal combustion engine with a NOx-storage catalytic converter was made known by the patent EP 944 424 B1. This catalytic converter has a core made from metal, which by way of admission can be heated with electric current.

The task underlying the invention is to specify a procedure to operate a hybrid vehicle and a device to implement the process, which allow for a low amount of exhaust emissions for hybrid vehicles.

The task is solved in each case by the specified characteristics in the independent claims.

### SUMMARY

The procedural approach according to the invention assumes that a specified torque target value can be obtained with successive addition of at least one internal combustion engine and at least one electromotor. In a first step the torque contribution of the internal combustion engine is established according to the invention as a function of at least one parameter of the exhaust of the internal combustion engine. In a second step the torque contribution of the electromotor is determined according to the invention on the basis of the difference between the torque target value and the torque contribution of the internal combustion engine established in the first step.

Determining the torque is concerned with the determination or specification of the drive power or drive capacity (engine output) which the driving motors of the hybrid vehicle are able to produce.

The establishment (specification) of the torque contribution of the internal combustion engine in the first step as a function of at least one parameter of the exhaust allows for an optimal operation of the internal combustion engine as far as emissions are concerned, which may deviate from an optimal operation as far as fuel consumption is concerned.

Advantageous modifications and embodiments of the procedure according to the invention result from dependent claims.

A parameter of the exhaust can be, for example, an undesirable exhaust component such as the NOx-concentration, the CO-concentration, the HC-concentration or the particle-concentration in the exhaust. By operating the internal combustion engine at a level of operation, at which at least one of these parameters has as low a value as possible, the amount of effort to bring about an additional required reduction of toxic exhaust components within the exhaust treatment device can be reduced.

Provision is made in another embodiment, that the parameter of the exhaust is the exhaust temperature. Preferably the exhaust temperature is specified with consideration of the operating temperature range of an available exhaust treatment device. In this regard it can be a matter of insuring the exhaust treatment device does not exceed the minimum operating temperature.

The exhaust treatment device concerns, for example, a catalytic converter or a particle filter. The catalytic converter requires a minimum operating temperature for the catalytic effect to take place. In so far as a storage catalytic converter, for example a NOx-storage catalytic converter, is concerned, the catalytic converter must be regenerated. For regeneration elevated temperatures from 450-600° C. are needed as compared to the normal operating temperature from, for example, 250-500° C. A particle filter when present requires likewise an elevated temperature to induce the regeneration, which, for example, can lie in the range from 600-650° C. The operation of the internal combustion engine with the goal of reaching the required temperature for the exhaust treatment device can be allowed for using the procedure according to the invention.

As a function of the task of optimizing the emissions, provision can be made that the optimizing of at least one of the exhaust components has precedence over a specification (an establishment) of the exhaust temperature. An electrical heating of the exhaust treatment device is conceived to provide for the instances where a securing of a required minimum operating temperature or the maintenance of a specified temperature range of the exhaust treatment device is required. This provision can especially be earmarked for the cold starting of an internal combustion engine, in which an electrical device in any case would have to be provided to insure that a minimum operating temperature of the exhaust treatment device is quickly achieved. After the cold starting phase has been accomplished, these provisions allow for the maintenance of the required operating temperature range.

Additional advantageous embodiments and modifications of the procedure according to the invention result from additional subordinate (dependent) claims and from the following description.

### BRIEF DESCRIPTION OF THE DRAWINGS

FIG. 1 shows a technical outlay, in which a procedure according to the invention is operating.

FIGS. 2 and 3 show characteristic curves of a parameter of an exhaust of an internal combustion engine as a function of (plotted against) the revolutions per minute (r.p.m.) and as a function of (plotted against) the torque.

FIG. 4 shows characteristic curves of an electromotor as a function of (plotted against) the revolutions per minute (r.p.m.) and as a function of (plotted against) the torque.

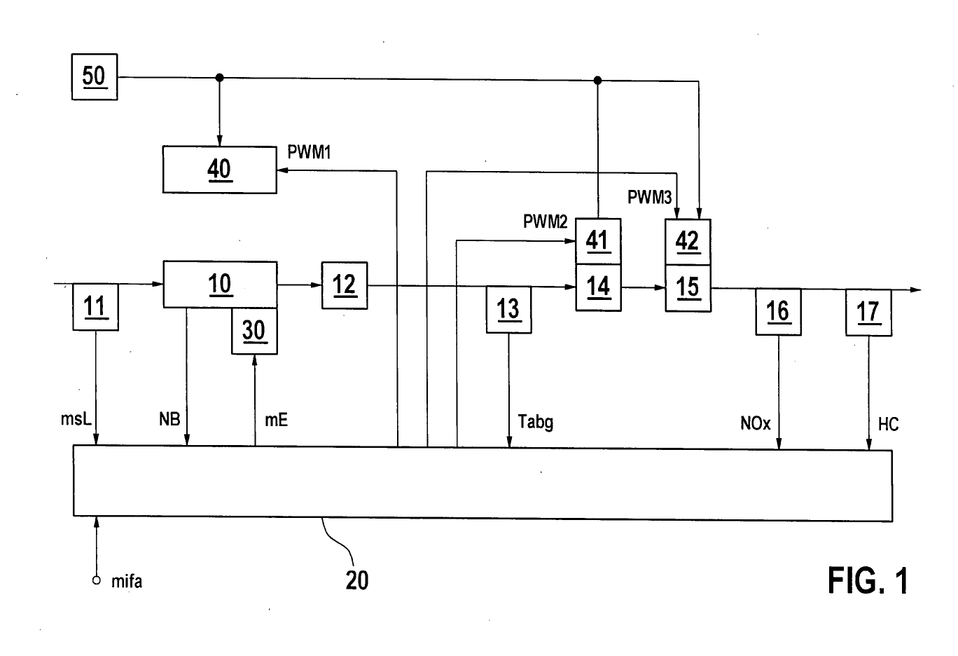

FIG. 1 shows an internal combustion engine 10, in whose air intake area an air sensor 11 is placed an in whose exhaust area a first catalytic converter 12, an exhaust temperature sensor 13, a particle filter 14, a second catalytic converter 15, a NOx-sensor 16 as well as an HC-sensor are arranged.

The air sensor 11 transmits an air signal msL, to a control unit 20, the exhaust temperature sensor 13 an exhaust temperature signal Tabg, the NOx-sensor 16 a NOx-signal NOx and the HC-sensor and HC-signal HCab.

The internal combustion engine 10 provides the control unit 20 with the revolutions per minute of the internal combustion engine NB. Furthermore, a torque target value mifa is supplied to the control unit 20.

A fuel metering device 30, which is charged with a fuel signal mE from the control unit 20, is attached to the internal combustion engine 10.

The control unit 20 transmits an initial activation signal PWM 1 to the electromotor 40, a second activation signal PWM 2 to a particle filter heating element 41 attached to the particle filter 14 and a third activation signal PWM 3 to a catalytic converter heating element 42 attached to the second catalytic converter 15.

An energy source 50 provides the electrical energy for the electromotor 40 as well as for the heating element of the particle filter 41 and the heating element for the catalytic converter 42.

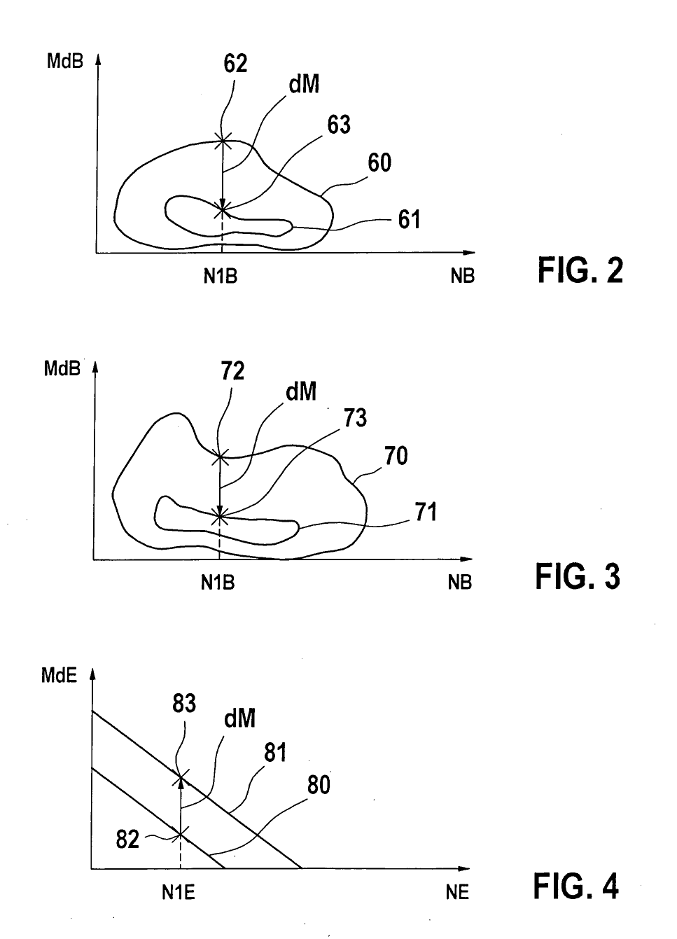

FIG. 2 shows a first and second curve progression 60, 61 of a parameter of the exhaust as a function of the revolutions per minute of the internal combustion engine NB and as a function of the torque MdB of the internal combustion engine 10. A first starting point 62 is plotted along the first curve progression 60 of the parameter of the exhaust at a certain number of revolutions per minute of the internal combustion engine N1B. A change of torque dM leads to a first target point 63, which lies on the second curve progression 61 of the parameter of the exhaust at a certain number of r.p.m. of the internal combustion engine N1B.

FIG. 3 shows a first and second curve progression 70, 71 of an additional parameter of the exhaust as a function of the r.p.m. of the internal combustion engine NB and as a function of the torque MdB of the internal combustion engine 10. On the first curve progression 71 of the additional parameter of the exhaust, a second starting point 72 is plotted at a certain number of r.p.m. of the internal combustion engine N1B. The change of torque dM leads to a second target point 63, which lies on the second curve progression 71 of the additional parameter of the exhaust at a certain number of r.p.m. of the internal combustion engine N1B.

FIG. 4 shows a first and a second characteristic curve 80, 81 of the electromotor 40 as a function of (plotted against) the r.p.m. of the electromotor NE and as a function of (plotted against) the torque of the electromotor MdE. On the first characteristic curve 80 of the electromotor 40 a third starting point 82 is plotted at a certain number of r.p.m. of the electromotor N1E. The change of torque dM leads to a third target point 83, which lies on the second characteristic curve 81 of the electromotor 40 at a certain number of r.p.m. of the electromotor N1E.

### DETAILED DESCRIPTION OF THE EMBODIMENTS

The arrangement shown in FIG. 1 with at least the one internal combustion engine 10 and at least the one electromotor 40 powers a hybrid vehicle. The internal combustion engine 10 and the electromotor 40 work, for example, by way of a transmission, which is not more closely specified, on at least one driving wheel of the hybrid vehicle. The coupling of the internal combustion engine 10 with the electromotor 40 can also thereby occur, in that a part of the electromotor 40 is attached directly to the output shaft of the internal combustion engine 10. The control unit 20 controls both the internal combustion engine 10 and the electromotor 40 as a function of the torque target value mifa, which, for example, corresponds to a position of the accelerator pedal of the hybrid vehicle which is here not more closely specified.

The term torque is not to be seen as limited to a torque as such. The term torque is to be understood much more generally as a measurement, for example, for a driving power or, for example, for a drive capacity (engine output), which is demanded by the hybrid vehicle.

The control unit 20 establishes the fuel signal mE, for example, as a function of the air signal msL and as a function of the number of r.p.m. of the internal combustion engine NB. The point of origin can be the first starting point 62, which lies on the first curve progression 60 of the parameter of the exhaust at a certain r.p.m. of the internal combustion engine N1B.

The parameter of the exhaust is, for example, a concentration of an undesirable exhaust component. The undesirable exhaust component can be the NOx-concentration which the NOx-sensor detects and/or that concentration which can be calculated based upon the known operating parameters of the internal combustion engine 10. The parameter of the exhaust can be alternatively or additionally the HC-concentration, which the HC-sensor 17 detects and/or that concentration which can be calculated on the basis of the known operating parameter of the internal combustion engine. The CO-concentration can alternatively or additionally be taken into consideration. Furthermore, the particle concentration can be the matter of concern, when considering the parameter of the exhaust.

In so far as more than one parameter of the exhaust are used, a compromise must be found, which includes all the parameters which have been taken into consideration.

The first curve progression 60 corresponds, for example, to a concentration of an undesirable NOx-concentration, which lies higher than the NOx-concentration which the second curve progression 61 reflects. In order to achieve a NOx-exhaust-gas emission before the catalytic converter of the internal combustion engine, which is as small as possible, it is, therefore, intended, that in the first step the torque contribution MdB of the internal combustion engine 10 is established as a function of at least one parameter of the exhaust, for example, as a function of the NOx-concentration. First of all the basic torque contributions of at least the one internal combustion engine 10 and of at least the one electromotor 40 of the hybrid vehicle are ascertained.

Instead of fixing the operating point of the internal combustion engine 10 at the first starting point 62 as done up to now, the operating point of the internal combustion engine 10 will now according to the invention be adjusted to the first target point 63. The establishment of the torque contribution MdB of the internal combustion engine 10, which was undertaken in the first step, corresponds to the torque MdB of the internal combustion engine 10 at the first target point 63.

The change in torque dM, which appears between the first starting point 62 and the first target point 63 at the certain number of r.p.m. of the internal combustion engine N1B, is associated with the specification (presetting) of the first target point. The change in torque dM also has an effect on other parameters of the exhaust. In FIG. 3 the initial and second curve progressions 70, 71 of an additional parameter of the exhaust are therefore plotted, whereby the change in torque dM occurs between the second starting point 72 and the second target point 73 at the certain number of r.p.m. of the internal combustion engine N1B. The additional parameter of the exhaust concerns, for example, the exhaust temperature which the exhaust temperature sensor 13 detects, and/or the temperature which can be calculated on the basis of the known operating parameters of the internal combustion engine 10. The initial curve progression 70 corresponds, for example, to a higher exhaust temperature than the second curve progression 71.

In the second step the torque contribution MdE of the electromotor 40 is determined on the basis of the difference between the torque target value mifa and the torque contribution established in the first step MdB of the internal combustion engine 10. As far as the change in torque dM concerned a reduction, the electromotor 40 has to produce a corresponding increase in the torque. The increase in the torque dM of the electromotor 40 is plotted in FIG. 4, whereby we proceed from the third starting point 82 to the third target point 83. The third starting point 82 is to be seen as unaffected by the change in torque contribution MdE of the electromotor 40 within the framework of the distribution of the torque contributions of at least the one internal combustion engine 10 and of at least the one electromotor 40 of the hybrid vehicle. The increase in torque dM takes place at the certain number of r.p.m. of the electromotor N1E, that does not have to be identical to the certain number of r.p.m. of the internal combustion engine N1B.

The characteristic curves depicted in FIG. 4 correspond to the functional connection between the number of r.p.m. and the torque of a direct current motor. In practice a synchronous machine is preferably employed as the electromotor.

The increase in the torque dM of the electromotor 40 to be undertaken in the example of the embodiment shown is performed by the control unit 20 by way of a change of the first activation signal PWM 1 of the electromotor 40. The first activation signal PWM 1 is, for example, a pulse-width-modulated signal, that changes the middle operating voltage of the electromotor 40, which is provided by the energy source 50. A variation of the operating voltage leads to a corresponding change of the motor's current, which (the current) is a measure of the torque MdE delivered by the electromotor 40.

In the depicted example of embodiment provision is made for an increase in the torque dM of the electromotor. Provision, however, can also be made for other operating states. For example, an increase in the torque dM of the internal combustion engine 10 can be earmarked for the targeted influencing of the parameter of the exhaust, whereby in this instance a reduction of the torque MdE of the electromotor 40 is then provided for. As a function of the operating situation, provision can be made, that the torque MdE of the electromotor 40 is nevertheless raised simultaneously (with that of the internal combustion engine). This operating situation can occur if a demand to charge the energy source appears. The charging of the energy source 50 can be achieved by way of operating the electromotor 40 as a generator. In this instance the internal combustion engine 10 drives the electromotor 40.

In the depicted example of embodiment according to FIG. 3, a lowering of the exhaust temperature is to be counted on by way of the transition from the first to the second curve progression 70, 71. A change in the exhaust temperature can influence the effectiveness of an exhaust treatment device. In the example of the embodiment shown, the exhaust treatment device contains the first and second catalytic converter 12, 15 as well as the particle filter 14. The catalytic reactions elapse optimally in a certain temperature range in the first catalytic converter 12, which if need be is provided and is, for example, an oxidation catalytic converter, and/or in the second catalytic converter, which if need be is provided and is, for example, a NOx-storage catalytic converter. The cleaning function of the exhaust can no longer take place beneath a specified minimum operating temperature. It must therefore be assured, that the operating temperature lies within the optimal operating temperature range, or at least exceeds the minimum operating temperature.

The particle filter 14, which if need be is present, as well as a second catalytic converter 15, which if need be is embodied as a storage catalytic converter 15, must be regenerated. The regeneration in the second catalytic converter 15 can necessitate an increased operating temperature compared to the storage operation. The regeneration of the particle filter 14 can necessitate a certain operating temperature at which the particles burn off by way of oxidation. The minimum operating temperatures required in each case can, for example, be achieved by way of a corresponding fixing of the exhaust temperature.

Were we to proceed from an undesirable exhaust component as the parameter for optimizing emissions, the case can occur, that the exhaust temperature is too low. In one embodiment provision is made for an electrical heating of the particle filter 14 and/or the second catalytic converter 15. The heating element for the particle filter 41 as well as the catalytic converter heating element 42 draw their electrical from an energy source 50. To implement the electrical heating, the control unit 20 activates the particle filter heating element 41 with the second activation signal PWM 2 and/or the catalytic converter heating element 42 with the third activation signal PWM 3. The control signals PWM 2, PWM 3 allow for a continuous (uninterrupted) regulation of the heating output.

According to another embodiment, provision is made for, that the electrical heating is implemented in each and every case. This operating state can, for example, occur when cold starting the internal combustion engine 10. At which time the required operating temperature of the exhaust treatment device 12, 14, 15 cannot be achieved independent of the fixing of the first target point 63. The operating temperature itself cannot be reached, if in the first step the exhaust temperature according to FIG. 3 is used as the parameter for optimizing the emissions.

The device according to the invention includes the necessary devices for implementation of the procedure. It concerns at least the control unit 20, in which the individual steps of the procedure occur. These steps are realized in the form of software.

1. A method for the operation of a hybrid vehicle, having at least one internal combustion engine and at least one electromotor, in which a specified torque target value is achieved, the method including determining a torque contribution of the internal combustion engine from at least one parameter of the exhaust, and determining a torque contribution of the electromotor from the differences between the torque target value and the torque contribution of the internal combustion engine.

2. A method according to claim 1, wherein the parameter of the exhaust is an undesirable exhaust component.

3. The method according to claim 2, wherein the undesirable exhaust component includes NOx, HC, CO, and Particle.

4. The method according to claim 1, wherein the parameter of the exhaust is the exhaust temperature.

5. The method according to claim 5, wherein the exhaust temperature is predetermined in regard to the operating temperature range of an exhaust treatment device.

6. The method according to claim 6, wherein the exhaust temperature is set in accordance with the operating temperature range of a catalytic converter or a particle filter.

7. The method according to claim 1, wherein the torque contributions of the electromotor is positive or negative.

8. The method according to claim 6, wherein an optimizing of at least one of the undesirable exhaust components has precedence over an establishment of the exhaust gas temperatures; and that in the case of an insufficient exhaust temperature, the exhaust treatment device is heated electrically to maintain the operating temperature range.

9. The method according to claim 6, wherein the exhaust treatment device is electrically heated when cold starting the internal combustion engine 10 to maintain the operating temperature range.

10. The method according to claim 1, wherein the parameter of the exhaust is the NOx-concentration.

11. (canceled)
